(19) United States
(12) Patent Application Publication
(10) Pub. No.: US 2025/0368511 A1
(43) Pub. Date: Dec. 4, 2025

(54) METHOD FOR OPERATING A NITRIC ACID PLANT AND NITRIC ACID PLANT

(71) Applicants: thyssenkrupp Uhde GmbH, Dortmund (DE); thyssenkrupp AG, Essen (DE)

(72) Inventors: Dirk RITTER, Essen (DE); Daniel BIRKE, Melle (DE)

(73) Assignees: thyssenkrupp Uhde GmbH, Dortmund (DE); thyssenkrupp AG, Essen (DE)

(21) Appl. No.: 18/875,324

(22) PCT Filed: Jun. 27, 2023
(86) PCT No.: PCT/EP2023/067496

§ 371 Date: Dec. 16, 2024

(30) Foreign Application Priority Data
Jun. 29, 2022 (DE) 10 2022 206 628.6

(51) Int. Cl. C01B 21/38

(52) U.S. Cl. CPC C01B 21/38

(57) ABSTRACT

A process for startup of a nitric acid plant comprises approaching at least one operating point according to a process pressure and a volume flow of the nitric acid plant, adjusting at least a portion of the process pressure via at least one offgas expander, and adjusting at least a portion of the volume flow via at least one compressor. The process, where startup is markedly simplified compared to the prior art, is characterized in that for allowable operating points a lower limit is specified according to pressure and volume flow and an upper limit is specified according to pressure and volume flow and in that it is indicated when upon adjustment of the pressure and/or the volume flow the lower limit or the upper limit is attained.

The invention relates to a process for startup of a nitric acid plant or for partial-load running, wherein at least one operating point is approached according to a process pressure and a volume flow of the nitric acid plant, wherein at least a portion of the process pressure is adjusted via at least one offgas expander, wherein at least a portion of the volume flow is adjusted via at least one compressor.

The invention further relates to a nitric acid plant comprising at least one compressor and comprising at least one offgas expander.

Nitric acid is an important raw material in the chemical industry and is used for example as a basis for producing fertilizer, explosives and for nitration of organic substances in the production of dyes and disinfectants.

Since the beginning of the 20th century, nitric acid has been produced according to the so-called Ostwald process, on which large-scale industrial production is still based today. This reaction is a catalytic reaction of ammonia. The resulting nitrogen monoxide reacts to afford nitrogen dioxide, from which nitric acid, which may be separated in trickle towers, is formed by reaction with water.

Production of nitric acid generally comprises initially reacting ammonia NH3 with air to produce nitric oxide NO, which is then further oxidized to afford nitrogen dioxide NO2. The thus-obtained nitrogen dioxide NO2 is subsequently absorbed in water to form nitric acid. In order that the greatest possible amount of the obtained nitrogen dioxide NO2 is absorbed by water, the absorption is generally carried out at elevated pressure, preferably at pressures between 4 to 14 bar. The oxygen required for the reaction of the ammonia raw material is generally supplied in the form of atmospheric oxygen. In order to supply it to the process, process air is compressed in a compressor and brought to a pressure that is adapted not only to the oxidation reaction but also to the absorption reaction.

The energy for compressing the air is typically obtained by decompression of the tail gas exiting the absorption to atmospheric pressure in a tail gas expander, also known as a tail gas turbine, and also by recovery of the heat liberated in the reactions. The nitric acid plants constructed in various configurations are in each case adapted to the specific requirements of their respective sites.

Production of nitric acid may be carried out in the one-pressure process or in the two-pressure process. In the one-pressure process both the combustion and the absorption are carried out at intermediate pressure (<8 bar) or high-pressure (>8 bar).

One-pressure processes are especially employed when the required daily production is low. In these cases, the nitric acid plant is preferably operated according to the mono-high-pressure process or according to the mono-intermediate-pressure process. In the mono-high-pressure process, the combustion of the ammonia and the absorption of the nitrogen oxides are carried out at approximately the same pressure of >8 bar. The advantage of the mono-high-pressure process is that a compact design is ensured.

In the mono-intermediate-pressure process, the combustion of the ammonia and the absorption of the nitrogen oxides are carried out at approximately the same pressure of <8 bar. The advantage of the mono-intermediate-pressure process is that an optimal combustion yield is ensured.

If, by contrast, large nominal capacities and/or relatively high acid concentrations are required a nitric acid plant configured according to the two-pressure process is the more economic solution. In the two-pressure process the combustion of the employed ammonia is carried out at a first pressure, namely at a lower pressure compared to the absorption pressure. The nitrous gases formed during the combustion, also known as nitrous gas, are generally brought to the second pressure, the absorption pressure, after cooling by nitrous gas compression. The advantage of the two-pressure process is that the pressure stages are adapted to the respective reactions, thus ensuring both an optimal combustion yield and a compact absorption.

The plants for performing the processes discussed hereinabove generally comprise at least one air compressor and at least one expansion turbine for the residual gas (also known as a tail gas turbine or offgas expander).

In contrast to steady-state operation, during startup and shutdown of nitric acid plants the apparatuses present do not operate under standard conditions
and often require additional control.

In the case of startup from the shutdown/cold state the nitric acid plant is generally initially filled with air (air operation) with import of external energy (for example external steam or electricity). The first emissions of NOx occur as soon as the absorption tower is filled with nitric acid from a reservoir container during the startup process and the nitrogen oxides present in the acid are blown out by the air, wherein present-day plants emit the NOx formed during the filling operation. Termination of the filling operation thus initially also causes the NOx emission to cease until the NH3 oxidation of the nitric acid plant is started (“ignited”). After ignition, the temperature and NOx concentration in the plant steadily increase to the steady-state operating value and the individual plant parts may be operated according to schedule after a certain time.

Startup comprises inter alia activation of the so-called “machine train”, i.e. the compressors and offgas expanders/turbines required for operation of the nitric acid plant. This is a sensitive system where changes to the settings of a compressor have an effect on the entire system similarly to corresponding settings on an exhaust gas expander/a turbine. Startup of the nitric acid plant therefore requires permanent and fine manual post-adjustment of the settings of the individual parts of the machine train.

The difficulty is that of approaching an operating point via the compressors and offgas expanders/turbines in such a way that no regions that lead to disruption of the production process or a tripping (safety-related shutdown) of the machine train and thus to stoppage of nitric acid production are approached. The same applies to the approach from normal or full-load operation to partial-load operation. Here too, the challenge is not to approach regions which could disrupt the production process or even trigger machine tripping.

It is accordingly an object of the present invention to specify a process for startup and for approaching the partial-load region of a nitric acid plant as well as a nitric acid plant where startup and adjustment of the partial-load operating points is simplified compared to the prior art.

This object is initially achieved by claim 1 in that for allowable operating points both a lower limit (4), dependent on a first pressure-dependent process parameter and a second flow-dependent process parameter, and an upper limit (5), dependent on the first pressure-dependent process parameter and the second flow-dependent process parameter, are specified and in that it is indicated when upon adjustment of the first process parameter and/or the second process parameter the lower limit (4) or the upper limit (5) is attained.

The first pressure-dependent process parameter may be for example a pressure, a pressure ratio, a delivery height or similar pressure-dependent parameters. Accordingly the second flow- dependent process parameter may be a throughput, a mass flow, a volume flow, a measurement aperture signal or flow rate signal or a similar flow-dependent parameter.

The lower limit is to be understood as meaning points at which the pressure and/or the volume flow have excessively low values. The upper limit is correspondingly to be understood as meaning points at which the pressure and/or the volume flow/the mass flow have excessively high values. Parameters that may be used include for example the final pressure or the polytropic delivery height. The lower and upper limits should therefore be considered analogously to characteristic curves. In compressor characteristic curves for example the relationship between the delivery height and the corresponding volume flow/throughput is represented graphically in a coordinate system. The volume flow may be plotted on the x-axis. It is also conceivable to display a flow signal, a mass flow, a dimensionless flow number, a delta P signal from a flowmeter or similar suitable parameters. The y-axis can show the delivery height. However, it is also conceivable to represent a pressure, a pressure ratio, a pressure-change work, a dimensionless pressure number or similar suitable parameters. The lower and upper limits define a map on which the permissible operating points of the nitric acid plant are located.

The machine set of the nitric acid plant according to the invention comprises at least one compressor and at least one offgas expander. The at least one compressor is an air compressor. The machine set may additionally further comprise at least one further compressor (NOx compressor) and a further drive machine, for example in the form of a drive steam turbine or drive gas turbine or an electric motor. The additional drive machine serves to provide the remaining energy required for operation of the machine set.

The advantage of the process according to the invention is that an operator is provided with a type of “parking aid” analogously to driving an automobile. The approach to the upper or lower limit may be indicated to the operator acoustically and/or visually or in another suitable way. The approach to one of the limits may also be indicated. The signals may become more distinct or energetic, the closer the current operating point is brought to the upper or lower limit. To this end it is possible to provide a region above which a first signal is issued before the lower or upper limit is reached.

Volume flow, pressure and temperature signals, which are processible for example by a machine control system, are required for the conversion of the required map values. These may be captured using suitable sensor data.

For the operation of the aforementioned two-pressure process it is provided in a first embodiment of the process according to the invention that a second compressor is used to adjust a second pressure level in a portion of the process of the nitric acid plant. Accordingly, the second compressor too belongs to the machine train and must be taken into account during startup of the nitric acid plant. The second compressor may be a compressor for compressing nitric oxide NO.

In a further preferred embodiment of the process according to the invention it is provided that the adjustment of the second flow-dependent process parameter is adjusted via the at least one compressor via control organs. The control organs may be formed in the form of adjustable guide vanes and/or a throttle valve. Conceivable further configurations of the control organs may also include adjustable control valves or similar suitable control organs which make it possible to control a volume flow. Control organs for adjusting the speed of the compressor for example would also be conceivable. Opening the control organs increases the volume flow/the mass flow. Closing the control organs reduces said flow.

It is accordingly provided in a further embodiment of the process according to the invention that the adjustment of the first pressure-dependent process parameters is adjusted via the at least one offgas expander via control organs. The control organs may be formed in the form of adjustable guide vanes and/or a throttle valve. Conceivable further configurations of the control organs may also include adjustable control valves or similar suitable control organs which make it possible to control a pressure. The process pressure is controlled via an inlet-side throttle valve and/or via adjustable guide vanes upstream of or in the offgas expander. Opening lowers the process pressure and thus also the outlet pressure from the NO compressor and the air compressor while closing increases it. Conceivable further configurations of the control organs may also include adjustable control valves or similar suitable control organs which make it possible to control a volume flow. Control organs for altering the speed of the offgas expander for example would also be conceivable.

In a further embodiment of the process according to the invention it is furthermore provided that the second flow-dependent process parameter is adjusted in part via the speed of the at least one compressor. The volume flow/the mass flow increases when the speed of the compressor is increased and decreases at correspondingly reduced speed.

In a further preferred embodiment of the process according to the invention it is provided that a warning is issued when upon adjustment of the first pressure-dependent process parameter and/or the second flow-dependent process parameter the lower limit or the upper limit is attained. The warning clearly signals to the operator that there is a need for action before the machine approaches regions in which operation of the nitric acid plant is no longer possible and production must be interrupted. This makes it possible for the operator to control corresponding parts of the machine train in the opposite direction.

In a further advantageous embodiment of the process according to the invention it is further provided that the adjustability of the at least one compressor and/or of the at least one offgas expander are blocked when upon adjustment of the first pressure-dependent process parameter and/or the second flow-dependent process parameter a previously defined lower approach limit to the lower limit or a previously defined upper approach limit to the upper limit is attained.

Since the system of the machine train reacts with a great deal of inertia during the adjustment it is advisable to define an approach limit upon whose attainment the control option is blocked, since the system has a tendency for overshooting. The approach limit ensures that while after the blocking the upper or lower limit may still be attained it will not be exceeded, with the result that there is no risk of operating the nitric acid plant in a region in which safe operation is no longer possible.

This makes it possible to prevent control in the wrong direction by the operator. This mechanism is comparable to an automatic braking system in a motor vehicle when the vehicle is brought too close to an obstacle.

In a particularly preferred embodiment of the process according to the invention it is provided that startup is performed stepwise in an automated manner. This means that while startup is performed by a machine control in fully automated fashion, stepwise startup is necessary since adjustment of the aforementioned control organs, i.e. throttle valve, adjustable guide vanes or speed alteration, can rapidly result in overshooting of the lower and/or upper limit on account of the inertia of the process. The adjustment of the control organs is therefore performed stepwise/in small steps. The control means thus assumes control of the control organs in a stepwise and controlled manner.

In order to further improve startup behavior and partial load behavior it is provided in a further embodiment of the process according to the invention that an approach speed to the lower limit and/or the upper limit is monitored.

It is further provided in a further embodiment of the invention that upon exceeding a previously specified first approach speed the adjustability of the at least one compressor and/or the at least one offgas expander is blocked. Similarly to a blocking of the adjustability upon attaining the lower or upper limit the attaining of a particular approach speed is potentially also harmful to the nitric acid plant since at an excessively high approach speed it can no longer be assumed that the system will not overshoot beyond the lower and/or the upper limit.

It may further be provided in a further embodiment of the process according to the invention that upon exceeding a previously specified second approach speed the at least one compressor and/or the at least one offgas expander is controlled in the opposite direction to the lower limit or upper limit. Should the approach speed be so great that an overshooting beyond the lower and/or the upper limit is no longer avoidable if no action is taken then the plant is actively controlled in the opposite direction. The degree of control may be dependent on the value of the approach speed.

The aforementioned object is also achieved by a nitric acid plant comprising at least one compressor and comprising at least one offgas expander, characterized in that the plant comprises a control means adapted for performing the process according to the invention.

All of the foregoing relating to the process also applies correspondingly to the nitric acid plant.

The nitric acid plant according to the invention is characterized in that the control means is adapted for identifying the movement of the operating points and taking action if the nitric acid plant is operated in automated fashion in that the control means sets a signal to L if the operating point of the compressor crosses the upper limit and in that the control means resets a signal to R if the operating point of the compressor falls below the lower limit, wherein according to the signals L and R the adjustable guide vanes of the offgas expander or of the compressor are opened or closed.

It is especially provided according to the invention that, through the signals of the control means,
the adjustable guide vanes of the compressor are opened and the adjustable guide vanes of the offgas expander are blocked if the operating point is to be shifted in the direction of an increase in the second flow-dependent process parameter and/or
to shift the operating point in the direction of an increase in the first pressure-dependent process parameter the adjustable guide vanes of the offgas expander are gradually closed while the adjustable guide vanes of the compressor are blocked,
wherein to shift the operating point in the opposite direction the steps are precisely reversed, i.e.
the adjustable guide vanes of the compressor are gradually closed if the operating point is to be shifted in the direction of a reduction in the second flow-dependent process parameter and/or
the adjustable guide vanes of the offgas expander are gradually opened to shift the operating point in the direction of a reduction in the first pressure-dependent process parameter.

There is a multitude of specific ways of configuring and developing the process of the invention the plant of the invention. In this regard, reference is made to the claims dependent on claim 1 and to the following description of preferred working examples in conjunction with the drawing. In the drawings

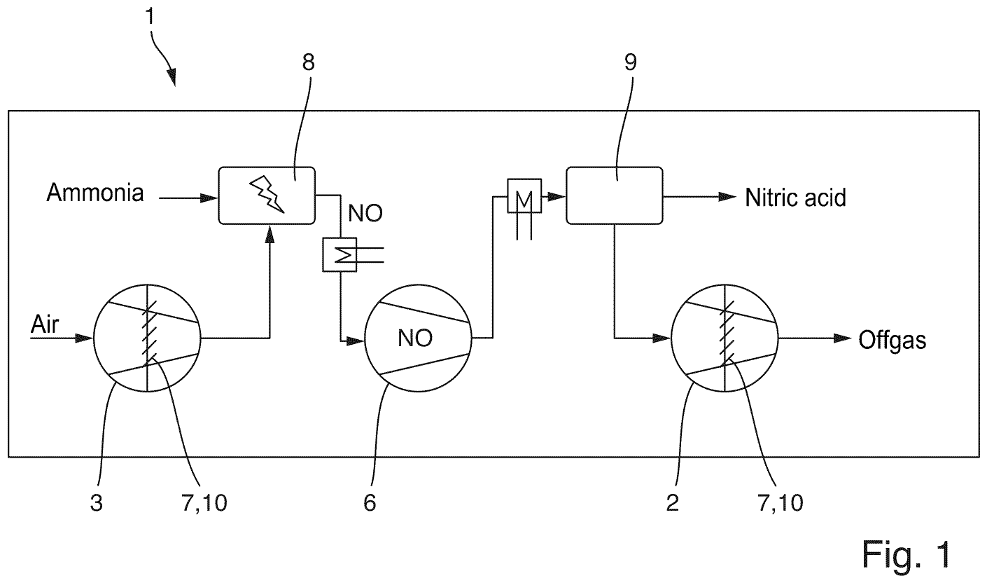

FIG. 1 is a schematic representation of a portion of a nitric acid plant,

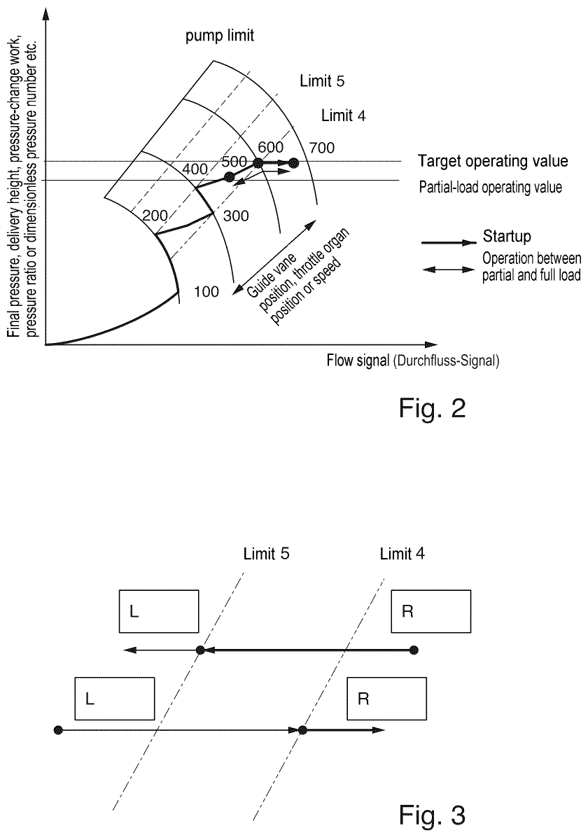

FIG. 2 is a schematic representation of the partial-load operation of a nitric acid plant with an embodiment of the process according to the invention and

FIG. 3 is a schematic representation of a controller logic for the automatic startup and partial-load operation of the nitric acid plant.

FIG. 1 shows a schematic representation of a nitric acid plant 1 with an offgas expander 2 and with a compressor 3 in the form of an air compressor. Compressors and offgas expanders are combined into a single machine train. In order to establish the correct operating point upon startup of the nitric acid plant 1, limits, namely a lower limit 4 and an upper limit 5, which are more particularly elucidated in FIG. 2, are specified. The nitric acid plant shown in FIG. 1 is operated according to the two-pressure process. Accordingly a second compressor 6 is provided and utilized for compressing nitrogen oxide NO to a second pressure level. The compressors 3, 6 and the offgas expander 2 may be controlled via control organs 7.

In general terms, in the nitric acid plant 1 shown in FIG. 1, ammonia NH3 is initially reacted in reactor 8 with air compressed by the compressor 3. This produces nitrogen oxide NO which is further oxidized to afford nitrogen dioxide NO2 and brought to a second pressure level by the second compressor 6. The thus-obtained nitrogen dioxide NO2 is subsequently absorbed in water in an absorber 9 to form nitric acid. The tail gas generated is decompressed via the offgas expander 2. Compressors 3 and 6 and exhaust gas expander 2 are controlled inter alia via adjustable guide vanes 10 as control organs.

FIG. 2 is a schematic diagram of the startup of the nitric acid plant 1. The volume flow (i.e. the second flow-dependent process variable) is plotted on the x-axis. The y-axis shows the final pressure downstream of the compressor 3 (in the one-pressure process) or the compressor 6 (in the two-pressure process) (i.e. the first pressure-dependent process parameter). In this exemplary embodiment startup is performed in automated fashion and in small steps. The gradual closing of the adjustable guide vanes 10 on the offgas expander 2 results in an increase in the compression ratio. The operating point moves from point 100 to the left, along a first operating line in the form of the upper limit 5 to point 200. After leaving the point a control means (not shown) blocks the adjustable guide vanes 10 of the offgas expander 2 and the adjustable guide vanes of the compressor 3 are gradually opened to increase the flow. The operating point moves to the right until a second operating line, the lower limit 4, is reached in point 300. At this point, the adjustable guide vanes of the compressor 3 are blocked by the control means and the adjustable guide vanes of the offgas expander 2 are closed further until the upper limit 5 is attained again in point 400.

This sequence is continued further until the target value of a partial-load point 500 (“partial-load operating value”) or the target value pressure of the normal/full-load point is attained in point 600. The compressor 3 has attained a target operating value line in point 600. This sequence can also be operated in reverse to safely control partial-load operating points, for example partial load point 500 at smaller amounts and optionally lower process pressures. During a manually operable mode the adjustable guide vanes 10 of the compressors 3 and 6 and the offgas expander 2 may be manually operated. However, the control means remains active and takes precedence over manually adjusted operating points.

Upon attaining the normal/full-load point 600 the compressor 3 only follows a horizontal “target operating value line” through further opening of the guide vanes of the compressor 3 to attain the overload point 700 of the nitric acid plant 1. From this point the system is no longer restricted by the limits 4 and 5. The inlet guide vanes of the exhaust gas expander 2 are not adjusted either.

During manual operation of the startup of nitric acid plant 1, blockings that prohibit the operator from controlling beyond the upper limit 5 or the lower limit 4 are provided. The upper limit 5 prevents machine tripping for example through:
Drastic mass flow reduction through excessive closing of the adjustable guide vanes 10 of the compressor 3. As soon as the operating point has attained this upper limit 5 the adjustable guide vanes 10 of the compressor 3 are blocked in the closing direction by the control means and—if necessary—minimally opened again by the control means until stable process conditions have been attained.
Drastic pressure increase through excessive closing of the adjustable guide vanes 10 of offgas expander 2. As soon as the operating point has attained the upper limit 5 the adjustable guide vanes 10 of the offgas expander 2 are blocked in the closing direction by the control means and—if necessary—minimally opened again by the control means until stable process conditions have been attained.
Drastic mass flow reduction through excessive speed reduction of the machine train. As soon as the operating point has attained the upper limit 5 the speed controller of the offgas expander 2 is blocked in the downward direction by the control means and—if necessary—the speed is minimally increased again by the control means until stable process conditions have been attained.

The upper limit 4 prevents process disruption for example through:
A too drastic mass flow increase through excessive opening of the adjustable guide vanes 10 of the compressor 3. As soon as the operating point has attained the lower limit 4 the adjustable guide vanes 10 of the compressor 3 are blocked in the opening direction by the control means and minimally opened again by the control means until stable process conditions have been attained.
A too drastic pressure reduction through excessive opening of the adjustable guide vanes 10 of the offgas expander 2. As soon as the operating point has attained the lower limit 4 the adjustable guide vanes 10 of the offgas expander 2 are blocked in the opening direction by the control means and—if necessary-minimally closed again by the control means until stable process conditions have been attained.
A too drastic mass flow increase through an excessive increase in speed of the machine train. As soon as the operating point has attained the lower limit 4 the speed controller of the offgas expander 2 is blocked in the upward direction by the control means and—if necessary—the speed is minimally reduced again by the control means until stable process conditions have been attained.

FIG. 3 shows how the control means detects the movement of the operating points and acts accordingly when the nitric acid plant 1 is operated in automated fashion. When the operating point of the compressor 3 crosses the upper limit 5, a signal is set to “L”. If the operating point of the compressor 3 falls below the lower limit 4 the signal is reset to “R”. According to the signals the adjustable guide vanes 10 of the offgas expander 2 or of the compressor 3 are opened or closed. The adjustable guide vanes 10 of the compressor 3 are opened when the operating point is to be shifted in the direction of an increase in the second flow-dependent process parameter, i.e. to the right-hand side, i.e. rightwards, in FIGS. 2 and 3. The adjustable guide vanes 10 of the offgas expander 2 are accordingly blocked. To shift the operating point in the direction of an increase in the first pressure-dependent process parameter, i.e. upwards in FIGS. 2 and 3, the adjustable guide vanes 10 of the offgas expander 2 are gradually closed while the adjustable guide vanes 10 of the compressor 3 are blocked. For the opposite direction, the steps are precisely reversed, i.e. the adjustable guide vanes 10 of the compressor 3 are gradually closed if the operating point is to be shifted in the direction of a reduction in the second flow-dependent process variable, i.e. to the left-hand side, i.e. leftwards, in FIGS. 2 and 3. The adjustable guide vanes 10 of the offgas expander 2 are gradually opened to shift the operating point in the direction of a reduction in the first pressure-dependent process variable, i.e. downwards in FIGS. 2 and 3.

### LIST OF REFERENCE SIGNS

(1) Nitric acid plant
(2) Offgas expander
(3) Compressor
(4) Lower limit
(5) Upper limit
(6) Second compressor
(7) Control organ
(8) Portion of nitric acid process, inter alia reactor for ammonia oxidation
(9) Portion of the nitric acid process, inter alia absorption and residual gas purification
(10) Adjustable guide vanes

1-14. (canceled)

15. A process for startup or for partial-load running of a nitric acid plant, comprising:
approaching at least one operating point according to a process pressure and a volume flow of the nitric acid plant;
adjusting at least a portion of the process pressure via at least one offgas expander; and
adjusting at least a portion of the volume flow via at least one compressor;
wherein, for allowable operating points both a lower limit, dependent on a first pressure-dependent process parameter and a second flow-dependent process parameter, and an upper limit, dependent on the first pressure-dependent process parameter and the second flow-dependent process parameter, are specified;
wherein it is indicated when upon adjustment of the first process parameter and/or the second process parameter the lower limit or the upper limit is attained.

16. The process as claimed in claim 15, wherein a second compressor is used to adjust a second pressure level in a portion of the process of the nitric acid plant.

17. The process as claimed in claim 15, wherein the adjustment of the flow-dependent second process parameter is adjusted via the at least one compressor via control organs.

18. The process as claimed in claim 15, wherein the adjustment of the first pressure-dependent process parameter is adjusted via the at least one offgas expander via control organs.

19. The process as claimed in claim 15, wherein the second flow-dependent process parameter is adjusted in part via the speed of the at least one compressor.

20. The process as claimed in claim 15, wherein a warning is issued when upon adjustment of the first pressure-dependent process parameter and/or the second flow-dependent process parameter the lower limit or the upper limit is attained.

21. The process as claimed in claim 15, wherein the adjustability of the at least one compressor and/or of the at least one offgas expander are blocked when upon adjustment of the first pressure-dependent process parameter and/or the second flow-dependent process parameter a previously defined lower approach limit to the lower limit or a previously defined upper approach limit to the upper limit is attained.

22. The process as claimed in claim 15, wherein startup is performed stepwise in an automated manner.

23. The process as claimed in claim 15, wherein an approach speed to the lower limit and/or the upper limit is monitored.

24. The process as claimed in claim 23, wherein upon exceeding a previously specified first approach speed the adjustability of the at least one compressor and/or the at least one offgas expander is blocked.

25. The process as claimed in claim 23, wherein upon exceeding a previously specified second approach speed the at least one compressor and/or the at least one offgas expander is controlled in the opposite direction to the lower limit or upper limit.

26. A nitric acid plant comprising at least one compressor and at least one offgas expander, wherein the plant comprises a controller configured to perform a process as claimed in claim 15.

27. The nitric acid plant as claimed in claim 26, wherein:
the controller is adapted for identifying the movement of the operating points and taking action if the nitric acid plant is operated in automated fashion;
the controller sets a signal to L if the operating point of the compressor crosses the upper limit;
the controller resets a signal to R if the operating point of the compressor falls below the lower limit; and
according to the signals L and R the adjustable guide vanes of the offgas expander or of the compressor are opened or closed.

28. The nitric acid plant as claimed in claim 26, wherein, through the signals of the controller:
the adjustable guide vanes of the compressor are opened and the adjustable guide vanes of the offgas expander are blocked if the operating point is to be shifted in the direction of an increase in the second flow-dependent process parameter and/or
to shift the operating point in the direction of an increase in the first pressure-dependent process parameter the adjustable guide vanes of the offgas expander are gradually closed while the adjustable guide vanes of the compressor are blocked,
wherein to shift the operating point in the opposite direction the steps are precisely reversed, i.e.
the adjustable guide vanes of the compressor are gradually closed if the operating point is to be shifted in the direction of a reduction in the second flow-dependent process parameter and/or
the adjustable guide vanes of the offgas expander are gradually opened to shift the operating point in the direction of a reduction in the first pressure-dependent process parameter.
